(19) United States
(12) Patent Application Publication
(10) Pub. No.: US 2019/0281072 A1
(43) Pub. Date: Sep. 12, 2019

(54) ASSET DISCOVERY USING ESTABLISHED NETWORK CONNECTIONS OF KNOWN ASSETS

(71) Applicant: Saudi Arabian Oil Company, Dhahran (SA)

(72) Inventor: Ali Abduladheem Al Khater, Dhahran (SA)

(21) Appl. No.: 15/914,703

(22) Filed: Mar. 7, 2018

(51) Int. Cl. H04L 29/06

(52) U.S. Cl. CPC H04L 63/1408; H04L 63/1433; H04L 63/164; H04L 63/0236; H04L 63/20

(57) ABSTRACT

Methods, systems, and apparatus, including computer programs encoded on a computer storage medium, for improving rock characterizations and providing information for more realistic and accurate numerical model building to assist in the characterizing porous media. In one aspect, a method includes the actions of receiving connections data from an asset on a network, wherein the connections data includes information regarding a plurality of established connections for the asset; extracting a plurality of destination Internet Protocol (IP) addresses for the established connections from the connections data; determining an undocumented asset on the network by comparing the extracted destination IP addresses with known IP addresses for an inventory of known enterprise assets; and implementing a security protocol regarding the undocumented asset.

### TECHNICAL FIELD

This disclosure relates to methods, systems, and apparatus for improving the discovery and tracking of assets connected to a network.

### BACKGROUND

One aspect of information security within an enterprise is the management of an enterprise network(s). Such enterprise network includes a variety of interconnected component systems that work together to collectively provide aggregate services to users. These users can use these services through a variety of computing devices or virtual hosts (assets) that are connected to the managed network over, for example, a wired or wireless connection. Furthermore, it is commonplace for such devices to connect, reconnect, and disconnect from the enterprise network, especially with regards to portable devices, such as laptops and smartphones. Accordingly, because the assets that are connected to a network can change over time, the discovery of what specific assets currently are or have connected to the network is a key piece of information for administrators to use to ensure the security and integrity of the managed network.

### SUMMARY

The present disclosure describes methods and systems, including computer-implemented methods, computer-program products, and computer systems for improving the discovery and tracking of assets connected to a network.

In a general implementation, connections data that includes information regarding a plurality of established connections for an on a network is received. A plurality of destination Internet Protocol (IP) addresses for the established connections is extracted from the connections data. An undocumented asset on the network is determined by comparing the extracted destination IP addresses with known IP addresses for an inventory of known enterprise assets. A security protocol is implemented regarding the undocumented asset.

Implementations include an asset discovery system. The described system can be implemented in a straightforward and inexpensive manner with a minor impact to overhead. Moreover, the described system may also employ other techniques of asset discovery, such as active and passive scanning to provide a robust and comprehensive asset discovery solution. By employing these multiple techniques, the described system increases the likelihood that a full picture of the current state a network and the assets connected to it can be produced.

The details of one or more implementations of the subject matter of this specification are set forth in the accompanying drawings and the later description. Other features, aspects, and advantages of the subject matter will become apparent from the description, the drawings, and the claims.

### DESCRIPTION OF DRAWINGS

FIG. 1 depicts an example environment 100 that can be employed to execute implementations of the present disclosure.

FIG. 2 depicts a block diagram of an example system that can execute implementations of the present disclosure.

FIG. 3 depicts a flow diagram of an example process to discover assets connected to a network.

FIG. 4 illustrates a block diagram of an exemplary computer system used to provide computational functionalities associated with described algorithms, methods, functions, processes, flows, and procedures as described in the instant disclosure, according to an implementation.

### DETAILED DESCRIPTION

This disclosure generally describes an optimization methodology for improving the discovery and tracking of assets connected to a network. The disclosure is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

In order to, for example, enforce policies and meet the compliance requirements for enumerating assets, an enterprise employs asset discovery for a managed network. Asset discovery is the method to determine what assets are or have been connected to a network. An asset is a device or virtual device capable of connecting to or exchanging data with the network. Types of assets include mobile devices, computers, routers, printers, cameras, appliances, electronics, wearables, and so forth. The determined asset information can be used to provide advanced services, such as searches, change management, and customizable advanced visualization. The information may also be used to a construct a blueprint or topology map of the network. Methods for asset discovery include active scanning, passive monitoring, and log analysis.

Active scanning involves sending transmissions to the nodes connected to a network. The responses for each node are parsed and analyzed to evaluate. A network administrator can also use an active scanner to simulate an attack on the network, uncovering weaknesses a potential hacker would spot, or examine a node following an attack to determine how a hacker breached security. Active scanning may fail to discover some assets that, for example, use a local firewall to block communication. Active scanning also consumes network traffic and may take a long time to complete, particularly as the size of a network increases.

Passive scanning, on the other hand, identifies the active operating systems, applications, and ports throughout a network by monitoring the activity on the network. In some implementations, passive scanning is performed by deploying appliances on specific locations on a network to monitor traffic. Depending on the complexity of the network, multiple appliances may be employed. Passive approach allows administrators to monitor the operating systems that are in use; what is being sent to, from, and within the network; which services are available; and where parts of the network may be vulnerable to security threats. Passive scanning may not identify devices on the network that are not communicating; for example, a device may be in a listen-only mode. Additionally, passive scanning may not be able identify network traffic routed outside of a span port, such as all local subnet traffic. The passive scanning may also not handle encrypted traffic well. In some implementations, passive scanning provides a continuous view of a network while active scanning provides more of a snapshot in time of a network. Similar to passive scanning, log files may also be analyzed to determine the assets that are using a network.

In view of the forgoing, the described system can be employed to discover assets connected to a network. The described system collects current established network connections from known assets to discover other assets that are connected to the same network. For example, a listing of the established connections in a web server may include all assets that a client(s) uses to visit the hosted website, as well as any other ongoing connections that may exist. By extracting this data from all known assets, the described system can be employed to show the active assets on the network. The discovered list can then be compared against known IP addresses for an inventory of known enterprise assets. Discrepancies between the lists show assets that are unknown or undocumented. For example, if an employee uses his or her own laptop to connect to the web server, the disclosed system can be employed to discovering the laptop on the network.

The described system can be implemented in a straightforward and inexpensive manner with a minor impact to overhead. Moreover, the described system may employ other techniques of asset discovery, such as active and passive scanning as described previously, to provide a robust and comprehensive asset discovery solution. By employing these multiple techniques, the described system increases the likelihood that a full picture of the current state of a network and the assets connected to it can be produced.

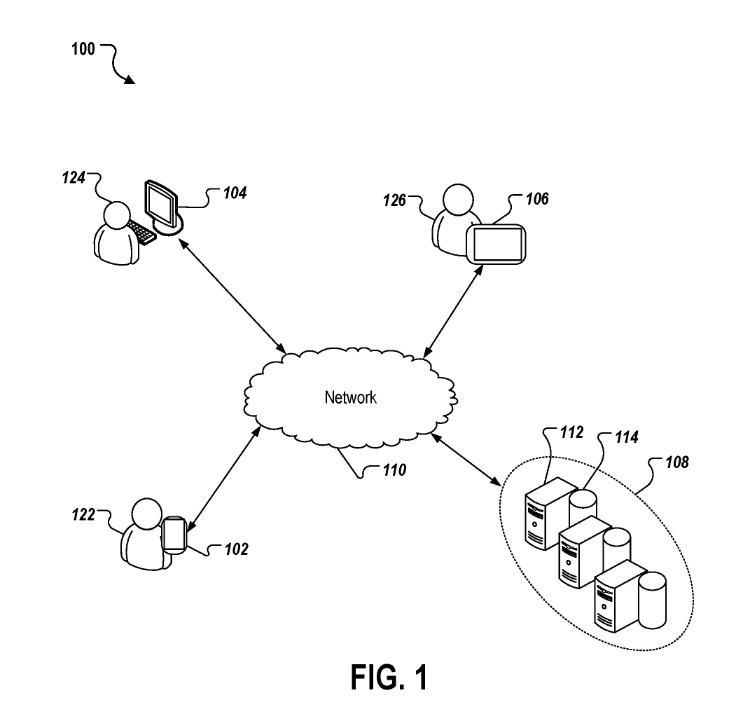

FIG. 1 depicts an example environment 100 that can be employed to execute implementations of the present disclosure. The example system 100 includes computing devices 102, 104, 106, a back-end system 108, and a network 110. The computing devices 102, 104, 106 may each include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the computing device 102 is provided as a smartphone, the computing device 104 is provided as a desktop computing device, and the computing device 106 is provided as a tablet-computing device. It is contemplated, however, that implementations of the present disclosure can be realized with any of the appropriate computing devices, such as those mentioned previously.

In the depicted example, the back-end system 108 includes at least one server system 112 and a data store 114. In some implementations, the at least one server system 112 hosts one or more computer-implemented services that users 122-126 can interact with using the respective computing devices 102-106. For example, the computing devices 102-106 are used by respective users 110-124 to log into and interact with the back-end system 108 over the network 110. In some implementations, back-end system 108 includes computer systems using clustered computers and components to act as a single pool of seamless resources when accessed through the network 110. For example, such implementations may be used in data center, cloud computing, storage area network (SAN), and network attached storage (NAS) applications. In some implementations, back-end system 108 is deployed using a virtual machine(s).

In some implementations, the network 110 includes a local area network (LAN), wide area network (WAN), the Internet, or a combination thereof, and connects web sites, devices, such as the computing device 102, 104, 106, and back-end systems, such as the back-end system 108. In some implementations, the network 110 can be accessed over a wired and/or a wireless communications link. For example, mobile computing devices, such as the smartphone device 102 and the tablet device 106, can utilize a cellular network to access the network 110.

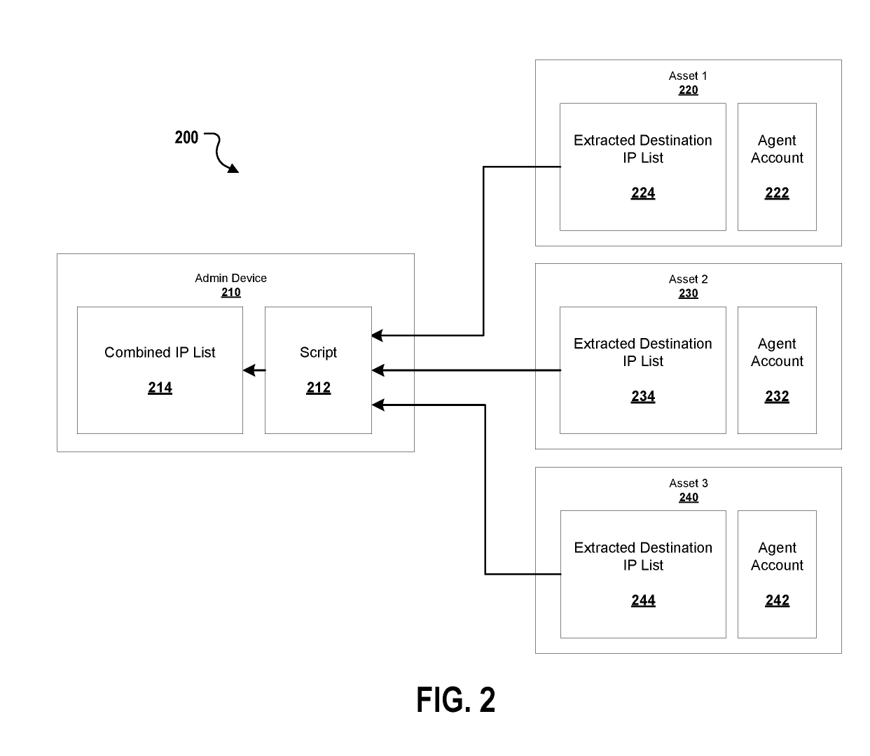

FIG. 2 depicts a block diagram of an example system 200 that can execute implementations of the present disclosure. The example system 200 system 200 may be implemented in an environment such as system 100 from FIG. 1. The example system 200 includes administrator device 220 and assets 220, 230, and 240, which are communicably coupled through a network, such as network 110 of FIG. 1. Assets 220, 230, and 240 are known assets in that the administrators have knowledge of the asset and have created an agent 222, 232, and 242 on each respective asset.

In the depicted implementation 200, a script 212 is executed to establish a connection with each asset 220, 230, 240 through a respective agent account (e.g., an administrator account) 222, 232, 242. In some implementations, the script is executed at a configured interval, which may be staggered for each asset. In some implementations, an administrator may execute script 212 manually or connect to each asset to generate and pull the respective extracted destination IP lists 224, 234, and 244.

Using the agent account 222, 232, and 242 for each respective asset 220, 230, and 240, the script 212 may employ, for example, a vulnerability scanner, such as Tenable Nessus™, or a security configuration management solution, such as Tripwire™, to generate an extracted destination IP list 224, 234, or 244 for each asset. For example, the script 212 may run a netstat (network statistics) on each asset 220, 230, and 240 to generate a list of established connections. netstat is a command-line network utility tool that displays network connections, both incoming and outgoing, for the Transmission Control Protocol (TCP); routing tables; and network interfaces, such as network interface controller and software-defined network interface; and network protocol statistics. Destination IP addresses are extracted from the list of established connections. In this context, a destination IP addresses is the IP address of a device to which a packet(s) is being sent. Localhost connections, such as those originating from 127.0.0.1, are removed to generate the extracted destination IP list 224, 234, and 244 for each respective asset 220, 230, and 242.

The script 212 receives the generated extracted destination IP lists 224, 234, and 244 for each asset and combines the results. Duplicated IP address are removed to generate the combined IP list 214. The combined IP list 214 highlights the assets that are actively communicating to known assets within the respective network on set intervals, such as hourly or 30-minute intervals. The combined IP list 214 is compared to the known IP addresses for the inventory of known enterprise assets. Discrepancies between the lists are used to determine whether any of the destination IP addresses are from unknown or undocumented assets. A security protocol(s) regarding the identified unknown or undocumented assets can then be implemented. Such a security protocol may include increasing the level of monitoring of the identified unknown or undocumented assets for further investigation. A security protocol may include blocking or isolating the unknown or undocumented assets from the network until, for example, the asset owner or functionality becomes known.

In an alternative embodiment, the script 212 employs an advanced logging option that is configured on each asset 220, 230, and 240. The advanced logging option configures each respective asset to log any incoming connection. The script 212 then pulls the list(s) of destination IP addresses from these log files.

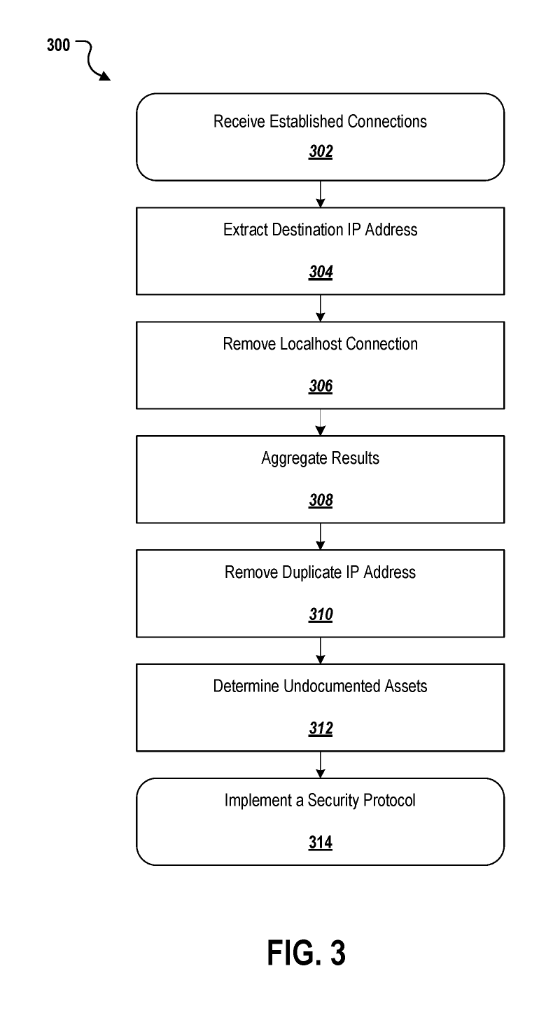

FIG. 3 depicts a flow diagram of an example process 300 to discover assets connected to a network. For clarity of presentation, the description that follows generally describes method 300 in the context of FIGS. 1, 2, and 4. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, or in any order.

At 302, a list of established connections from an asset within a network is received. The list may be generated with a vulnerability scanner or through a command function, such as netstat. The list includes, for example, the TCP network connections, both incoming and outgoing currently connected to the asset. From 302, the process 300 proceeds to 304. At 304, the destination IP addresses are extracted from the received list, and the process 300 moves to 306. At 306, the localhost connections are removed from the remaining extracted destination IP, and the process moves to 308, which is an optional step. At 308, the results are aggregated with a list of established connections received from other assets within the network and filtered according to steps 304 and 306. From 308, the process 300 moves to 310. At 310, duplicate IP addresses are removed from the aggregated list, and the process 300 moves to 312. At 312, unknown or undocumented assets on the network are determined by a comparison of the aggregated and filtered list of established connections with known IP addresses for an inventory of known enterprise assets. From 312, the process 300 moves to 314. At 314, a security protocol(s) regarding the identified unknown or undocumented assets is implemented. Such a security protocol may include increasing the level of monitoring of the identified unknown or undocumented assets for further investigation. A security protocol may include blocking or isolating the unknown or undocumented assets from the network until, for example, the asset owner or functionality becomes known. From 316, the process 300 ends.

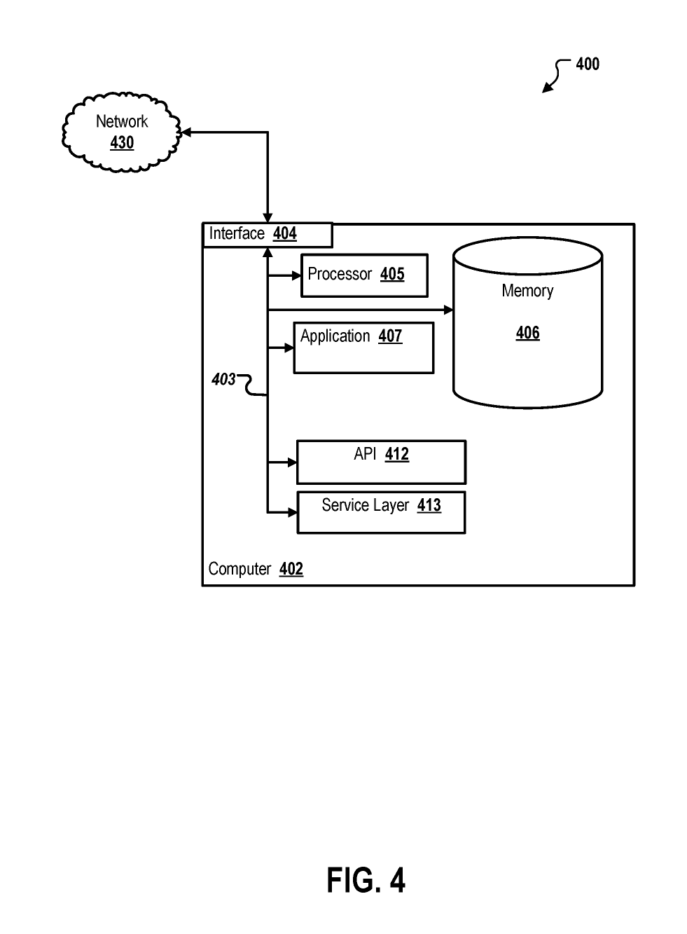

FIG. 4 depicts a block diagram of an exemplary computer system 400 used to provide computational functionalities associated with described algorithms, methods, functions, processes, flows, and procedures as described in the instant disclosure, according to an implementation. The illustrated computer 402 is intended to encompass any computing device such as a server, desktop computer, laptop or notebook computer, wireless data port, smart phone, personal data assistant (PDA), tablet computing device, one or more processors within these devices, or any other suitable processing device, including both physical or virtual instances (or both) of the computing device. Additionally, the computer 402 may comprise a computer that includes an input device, such as a keypad, keyboard, touch screen, or other device that can accept user information, and an output device that conveys information associated with the operation of the computer 402, including digital data, visual, or audio information (or a combination of information), or a GUI.

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an application programming interface (API) 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined business functionalities through a defined interface. For example, the interface may be software written in JAVA, C++, or other suitable language providing data in extensible markup language (XML) format or other suitable format. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a memory 406 that holds data for the computer 402 or other components (or a combination of both) that can be connected to the network 430 (whether illustrated or not). For example, memory 406 can be a database storing data consistent with this disclosure. Although illustrated as a single memory 406 in FIG. 4, two or more memories may be used according to particular needs, desires, or particular implementations of the computer 402 and the described functionality. While memory 406 is illustrated as an integral component of the computer 402, in alternative implementations, memory 406 can be external to the computer 402.

The application 407 is an algorithmic software engine providing functionality according to particular needs, desires, or particular implementations of the computer 402, particularly with respect to functionality described in this disclosure. For example, application 407 can serve as one or more components, modules, applications, etc. Further, although illustrated as a single application 407, the application 407 may be implemented as multiple applications 407 on the computer 402. In addition, although illustrated as integral to the computer 402, in alternative implementations, the application 407 can be external to the computer 402.

There may be any number of computers 402 associated with, or external to, a computer system containing computer 402, each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

Described implementations of the subject matter can include one or more features, alone or in combination. For example, in a first implementation, a computer-implemented method, executed by one or more processors, comprises: receiving connections data from an asset on a network, wherein the connections data includes information regarding a plurality of established connections for the asset; extracting a plurality of destination Internet Protocol (IP) addresses for the established connections from the connections data; determining an undocumented asset on the network by comparing the extracted destination IP addresses with known IP addresses for an inventory of known enterprise assets; and implementing a security protocol regarding the undocumented asset.

The foregoing and other described implementations can each optionally include one or more of the following features.

A first feature, combinable with any of the following features, wherein the security protocol includes an implementation of an increased level on monitoring of the undocumented asset.

A second feature, combinable with any of the previous or following features, wherein the security protocol includes disconnecting or isolating the undocumented asset from the network.

A third feature, combinable with any of the previous or following features, wherein the method further comprises: before determining the undocumented asset on the network, aggregating the extracted destination IP addresses with destination IP addresses extracted from a plurality of other assets on the network.

A fourth feature, combinable with any of the previous or following features, wherein the method further comprises: before determining the undocumented asset on the network, removing duplicate destination IP addresses from the aggregated extracted destination IP addresses.

A fifth feature, combinable with any of the previous or following features, wherein extracting the destination IP addresses includes removing localhost connections.

A sixth feature, combinable with any of the previous or following features, wherein the established connections include incoming and outgoing TCP connections for the asset received on a set interval.

A seventh feature, combinable with any of the previous or following features, wherein the established connections are generated from a vulnerability scanner.

An eighth feature, combinable with any of the previous or following features, wherein the established connections are generated from a netstat command executed on the asset.

A ninth feature, combinable with any of the previous or following features, wherein the undocumented asset on the network is further determined based on passive scanning and active scanning of the network.

A tenth feature, combinable with any of the previous or following features wherein the method further comprises: accessing the asset through an agent account; and prompting the asset to send the established connections.

In a second implementation, one or more non-transitory computer-readable storage media coupled to one or more processors and having instructions stored thereon which, when executed by the one or more processors, cause the one or more processors to perform operations comprising: receiving connections data from an asset on a network, wherein the connections data includes information regarding a plurality of established connections for the asset; extracting a plurality of destination Internet Protocol (IP) addresses for the established connections from the connections data; determining an undocumented asset on the network by comparing the extracted destination IP addresses with known IP addresses for an inventory of known enterprise assets; and implementing a security protocol regarding the undocumented asset.

The foregoing and other described implementations can each optionally include one or more of the following features.

A first feature, combinable with any of the following features, wherein the security protocol includes an implementation of an increased level on monitoring of the undocumented asset.

A second feature, combinable with any of the previous or following features, wherein the security protocol includes disconnecting or isolating the undocumented asset from the network.

A third feature, combinable with any of the previous or following features, wherein the operations further comprise: before determining the undocumented asset on the network, aggregating the extracted destination IP addresses with destination IP addresses extracted from a plurality of other assets on the network.

A fourth feature, combinable with any of the previous or following features, wherein the operations further comprise: before determining the undocumented asset on the network, removing duplicate destination IP addresses from the aggregated extracted destination IP addresses.

A fifth feature, combinable with any of the previous or following features, wherein extracting the destination IP addresses includes removing localhost connections.

A sixth feature, combinable with any of the previous or following features, wherein the established connections include incoming and outgoing TCP connections for the asset received on a set interval.

A seventh feature, combinable with any of the previous or following features, wherein the established connections are generated from a vulnerability scanner.

An eighth feature, combinable with any of the previous or following features, wherein the established connections are generated from a netstat command executed on the asset.

A ninth feature, combinable with any of the previous or following features, wherein the undocumented asset on the network is further determined based on passive scanning and active scanning of the network.

A tenth feature, combinable with any of the previous or following features wherein the operations further comprise: accessing the asset through an agent account; and prompting the asset to send the established connections.

In a third implementation, a computer-implemented system, comprising: one or more processors; and a computer-readable storage device coupled to the one or more processors and having instructions stored thereon which, when executed by the one or more processors, cause the one or more processors to perform operations comprising: receiving connections data from an asset on a network, wherein the connections data includes information regarding a plurality of established connections for the asset; extracting a plurality of destination Internet Protocol (IP) addresses for the established connections from the connections data; determining an undocumented asset on the network by comparing the extracted destination IP addresses with known IP addresses for an inventory of known enterprise assets; and implementing a security protocol regarding the undocumented asset.

The foregoing and other described implementations can each optionally include one or more of the following features.

A first feature, combinable with any of the following features, wherein the security protocol includes an implementation of an increased level on monitoring of the undocumented asset.

A second feature, combinable with any of the previous or following features, wherein the security protocol includes disconnecting or isolating the undocumented asset from the network.

A third feature, combinable with any of the previous or following features, wherein the operations further comprise: before determining the undocumented asset on the network, aggregating the extracted destination IP addresses with destination IP addresses extracted from a plurality of other assets on the network.

A fourth feature, combinable with any of the previous or following features, wherein the operations further comprise: before determining the undocumented asset on the network, removing duplicate destination IP addresses from the aggregated extracted destination IP addresses.

A fifth feature, combinable with any of the previous or following features, wherein extracting the destination IP addresses includes removing localhost connections.

A sixth feature, combinable with any of the previous or following features, wherein the established connections include incoming and outgoing TCP connections for the asset received on a set interval.

A seventh feature, combinable with any of the previous or following features, wherein the established connections are generated from a vulnerability scanner.

An eighth feature, combinable with any of the previous or following features, wherein the established connections are generated from a netstat command executed on the asset.

A ninth feature, combinable with any of the previous or following features, wherein the undocumented asset on the network is further determined based on passive scanning and active scanning of the network.

A tenth feature, combinable with any of the previous or following features wherein the operations further comprise: accessing the asset through an agent account; and prompting the asset to send the established connections.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an application programming interface (API) or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier description of example implementations does not define or constrain this disclosure. Other changes, substitutions, and alterations are also possible without departing from the spirit and scope of this disclosure.

Furthermore, any claimed implementation described later is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A computer-implemented method executed by one or more processors, the method comprising:
receiving connections data from an asset on a network, wherein the connections data includes information regarding a plurality of established connections for the asset;
extracting a plurality of destination Internet Protocol (IP) addresses for the established connections from the connections data;
determining an undocumented asset on the network by comparing the extracted destination IP addresses with known IP addresses for an inventory of known enterprise assets; and
implementing a security protocol regarding the undocumented asset.

2. The method of claim 1, wherein the security protocol includes an implementation of an increased level on monitoring of the undocumented asset.

3. The method of claim 1, wherein the security protocol includes disconnecting or isolating the undocumented asset from the network.

4. The method of claim 1, further comprising:
before determining the undocumented asset on the network, aggregating the extracted destination IP addresses with destination IP addresses extracted from a plurality of other assets on the network.

5. The method of claim 4, further comprising:
before determining the undocumented asset on the network, removing duplicate destination IP addresses from the aggregated extracted destination IP addresses.

6. The method of claim 1, wherein extracting the destination IP addresses includes removing localhost connections.

7. The method of claim 1, wherein the established connections include incoming and outgoing Transmission Control Protocol (TCP) connections for the asset received on a set interval.

8. The method of claim 1, wherein the established connections are generated from a vulnerability scanner.

9. The method of claim 1, wherein the established connections are generated from a netstat command executed on the asset.

10. The method of claim 1, wherein the undocumented asset on the network is further determined based on passive scanning and active scanning of the network.

11. The method of claim 1, further comprising:
accessing the asset through an agent account; and
prompting the asset to send the established connections.

12. One or more non-transitory computer-readable storage media coupled to one or more processors and having instructions stored thereon which, when executed by the one or more processors, cause the one or more processors to perform operations comprising:
receiving connections data from an asset on a network, wherein the connections data includes information regarding a plurality of established connections for the asset;
extracting a plurality of destination Internet Protocol (IP) addresses for the established connections from the connections data;
determining an undocumented asset on the network by comparing the extracted destination IP addresses with known IP addresses for an inventory of known enterprise assets; and
implementing a security protocol regarding the undocumented asset.

13. The one or more non-transitory computer-readable storage media of claim 12, wherein the security protocol includes disconnecting or isolating the undocumented asset from the network.

14. The one or more non-transitory computer-readable storage media of claim 12, wherein the operations comprise:
before determining the undocumented asset on the network, aggregating the extracted destination IP addresses with destination IP addresses extracted from a plurality of other assets on the network.

15. The one or more non-transitory computer-readable storage media of claim 14, wherein the operations comprise:
before determining the undocumented asset on the network, removing duplicate destination IP addresses from the aggregated extracted destination IP addresses.

16. A computer-implemented system, comprising:
one or more processors; and
a computer-readable storage device coupled to the one or more processors and having instructions stored thereon which, when executed by the one or more processors, cause the one or more processors to perform operations comprising:
receiving connections data from an asset on a network, wherein the connections data includes information regarding a plurality of established connections for the asset;
extracting a plurality of destination Internet Protocol (IP) addresses for the established connections from the connections data;
determining an undocumented asset on the network by comparing the extracted destination IP addresses with known IP addresses for an inventory of known enterprise assets; and
implementing a security protocol regarding the undocumented asset.

17. The computer-implemented system of claim 16, wherein the security protocol includes an implementation of an increased level on monitoring of the undocumented asset.

18. The computer-implemented system of claim 16, wherein the established connections include incoming and outgoing Transmission Control Protocol (TCP) connections for the asset received on a set interval

19. The computer-implemented system of claim 16, wherein the undocumented asset on the network is further determined based on passive scanning and active scanning of the network.

20. The computer-implemented system of claim 16, wherein the operations further comprise:
accessing the asset through an agent account; and
prompting the asset to send the established connections.
